(19) United States
(12) Patent Application Publication
(10) Pub. No.: US 2010/0264170 A1
(43) Pub. Date: Oct. 21, 2010

(54) QUANTITATIVE POWDER MATERIAL DISPENSER

(76) Inventor: Hui-Peng Chiu, Taoyuan City (TW)

Correspondence Address: Yen Jung Sung, 21-80 38 St, #C8, Astoria, NY, 11105, US

(21) Appl. No.: 12/764,041

(22) Filed: Apr. 20, 2010

(30) Foreign Application Priority Data
Apr. 21, 2009 (TW) 098206604

(51) Int. Cl. G01F 11/20; G01F 11/10

(52) U.S. Cl. 222/239; 222/370

(57) ABSTRACT

A quantitative powder material dispenser includes a base frame having a center coupling hole and an eccentric dispensing hole, a dispensing wheel rotatably supported on the base frame and having equiangularly spaced through holes and a bottom pivot shaft that is inserted through the center coupling hole of the base frame, a barrel fastened to the base frame around the dispensing wheel to hold a powder material and having an inside scraper blade kept in contact with the dispensing wheel above the through holes, and a driving device connected to the pivot shaft and controlled to rotate the dispensing wheel relative to the base frame for enabling the powder material to be dispensed through the dispensing hole quantitatively at a predetermined time interval subject to the speed of rotation of the dispensing wheel.

### BACKGROUND OF THE INVENTION

1. Field of the Invention

The present invention relates to a power material dispensing technology and more particularly, to a quantitative powder material dispenser, which dispenses a powder material automatically and quantitatively, avoiding contamination.

2. Description of the Related Art

Commercial powdered milk generally has a measuring cup attached to the can or bag package so that the user can use the attached measuring cup to measure the desired volume of powdered milk for serving the baby. However, when using the measuring cup to measure the desired volume of powdered milk for mixing with driving water, the user's hand touches the measuring cup directly, and bacteria may be transferred from the user's hand to the measuring cup. When the measuring cup is put back in the can or bag package of powdered milk after the service, the powdered milk may be contaminated by bacteria at the measuring cup. Feeding a baby with contaminated powdered milk can cause the baby to be sick. This contamination problem may also be encountered during the preparation of coffee or other drinks.

### SUMMARY OF THE INVENTION

The present invention has been accomplished under the circumstances in view. It is the main object of the present invention to provide a quantitative powder material dispenser, which automatically quantitatively dispenses a powder material at a predetermined time interval, avoiding contamination.

To achieve this and other objects of the present invention, a quantitative powder material dispenser comprises a base frame, which has a center coupling hole and a dispensing hole spaced from the center coupling hole at one side at a predetermined distance, a dispensing wheel, which is supported on and rotatable relative to the base frame and comprises a wheel body having equiangularly spaced through holes and a bottom pivot shaft that is inserted through the center coupling hole of the base frame, a barrel, which is fastened to the base frame around the dispensing wheel for holding a powder material in an open chamber therein and which has an inside scraper blade kept in contact with the wheel body of the dispensing wheel above the through holes, and a driving device connected to the bottom pivot shaft of the dispensing wheel and adapted for rotating the dispensing wheel relative to the base frame.

### BRIEF DESCRIPTION OF THE DRAWINGS

FIG. 1 is a cutaway view of a quantitative feed dispenser in accordance with the present invention.

FIG. 2 is an exploded view of the quantitative feed dispenser in accordance with the present invention.

FIG. 3 is a top view of the quantitative feed dispenser in accordance with the present invention.

FIG. 4 is a sectional view taken along line A-A of FIG. 3.

FIG. 5 is a cutaway view of an alternate form of the quantitative feed dispenser in accordance with the present invention.

### DETAILED DESCRIPTION OF THE PREFERRED EMBODIMENT

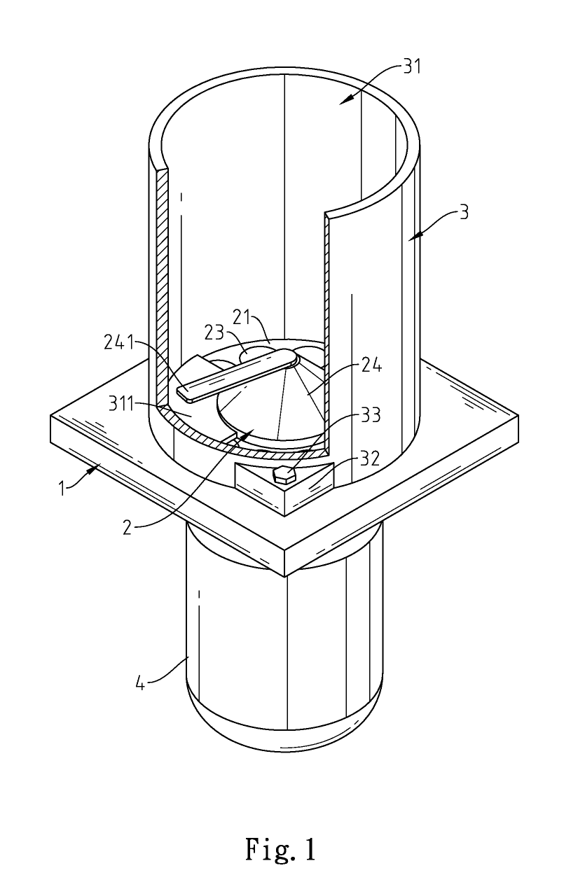

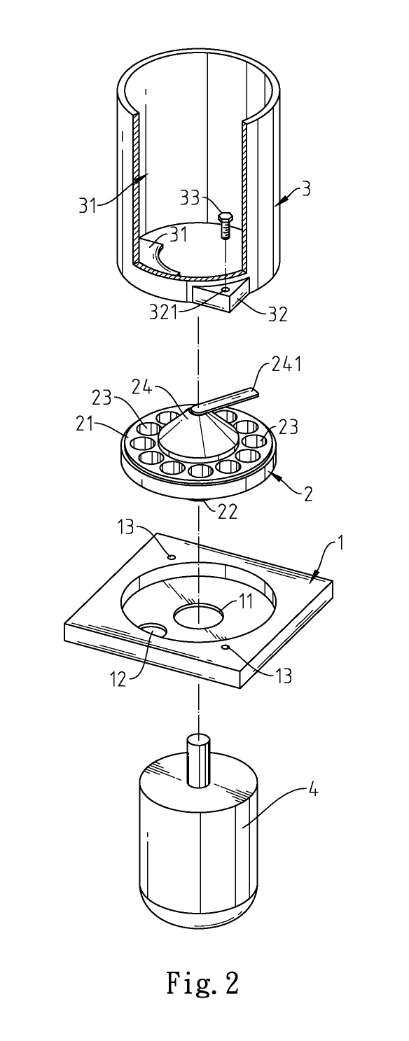

Referring to FIGS. 1 and 2, a quantitative powder material dispenser in accordance with the present invention is shown comprising a base frame 1, a dispensing wheel 2, a barrel 3 and a driving device 4.

The base frame 1 has a center coupling hole 11, a dispensing hole 12 spaced from the center coupling hole 11 at one side at a predetermined distance, and a plurality of mounting holes 13 located near the border.

The dispensing wheel 2 comprises a wheel body 21, which has a plurality of through holes 23 equiangularly spaced around the border, a pivot shaft 22 perpendicularly downwardly extended from the center of the bottom wall of the wheel body 21, a guide block 24 shaped like a truncated cone and located at the center of the top wall of the wheel body 21, and a stir bar 241 transversely extended from the flat topmost edge of the guide block 24 and suspending above the wheel body 21.

The barrel 3 defines therein an open chamber 31 for holding a powder material, having a scraper blade 311 transversely mounted in the open chamber 31 at the bottom side, a plurality of mounting blocks 32 symmetrically disposed at the bottom side outside the open chamber 31 and a plurality of mounting through holes 321 respectively cut through the mounting blocks 32 corresponding to the mounting holes 13 of the base frame 1.

The driving device 4 can be, for example, a motor.

During installation of the present invention, attach the dispensing wheel 2 to the top side of the base frame 1 to insert the pivot shaft 22 through the coupling hole 11 of the base frame 1, and then attach the barrel 3 to the base frame 1 around the dispensing wheel 2, and then insert fastening members, for example, screws 33 through the mounting through holes 321 and drive the screws 33 into the mounting holes 13 of the base frame 1 to affix the barrel 3 to the base frame 1, keeping the scraper blade 311 of the barrel 3 in contact with the top surface of the wheel body 21 of the dispensing wheel 2, and then connect the driving device 4 to the pivot shaft 22 below the base frame 1.

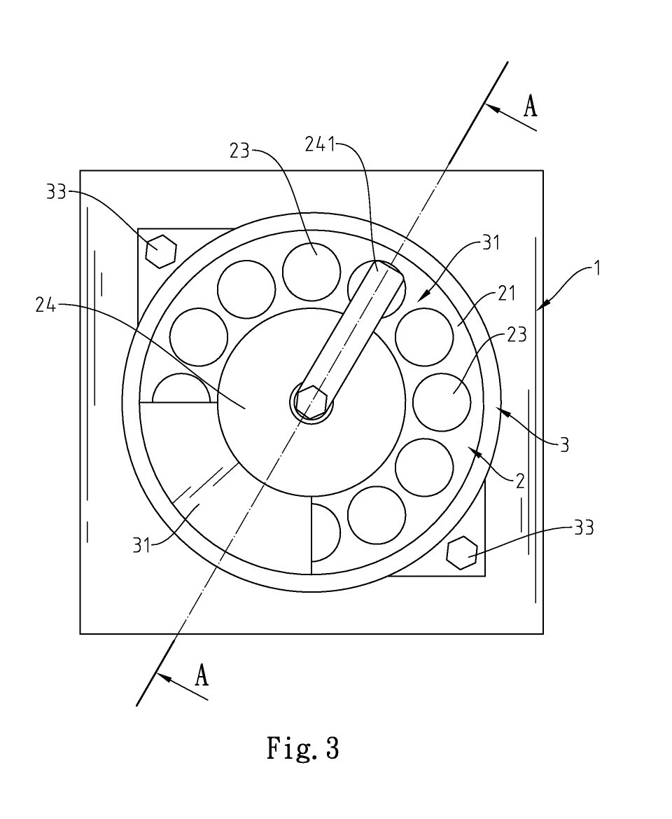

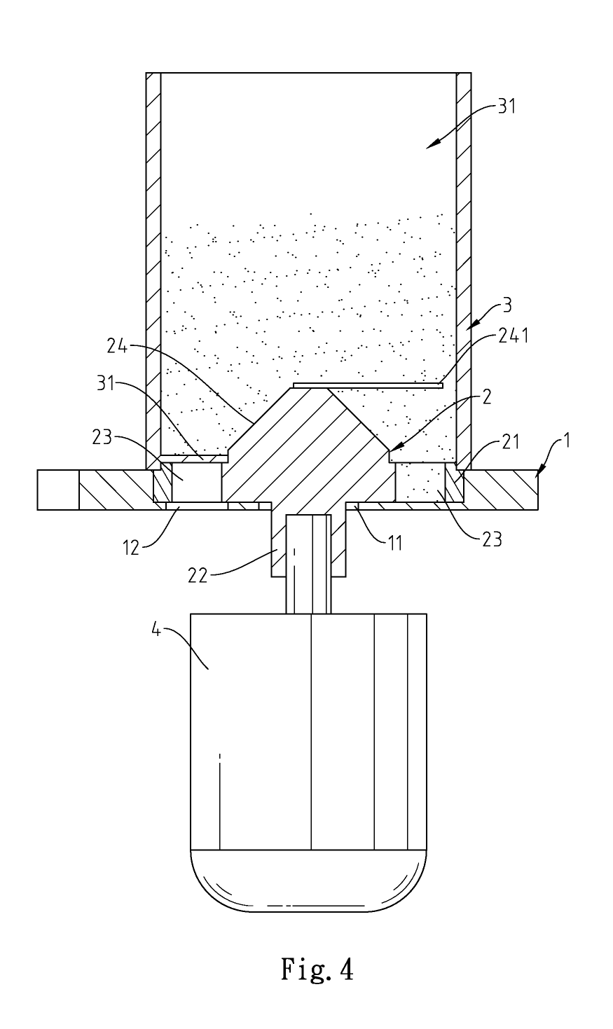

Referring to FIGS. 3 and 4, during the use of the present invention, the powder material to be dispensed is put in the open chamber 31 in the barrel 3. At this time, the powder material falls into the through holes 23 that are exposed to the outside of the scraper blade 311. However, because the base frame 1 blocks the bottom side of the dispensing wheel 2, the powder material will not fall out of the through holes 23. When started the driving device 4 to rotate the dispensing wheel 2, the through holes 23 are sequentially moved through the bottom side of the scraper blade 311 of the barrel 3. At this time, the scraper blade 311 removes the powder material above the through holes 23 and the powder material that is received in each through hole 23 falls from each through hole 23 that reaches the dispensing hole 12 of the base frame 1. Therefore, a constant amount of the powder material (substantially equal to the volume of one through hole 23) is dispensed through the dispensing hole 12 for service at a predetermined time interval subject to the speed of rotation of the dispensing wheel 2. Because the powder material is dispensed quantitatively and automatically, the user does not touch the powder material directly, avoiding contamination.

Further, the driving device 4 can be controlled to rotate the dispensing wheel 2 step-by-step for enabling a predetermined number of the through holes 23 to pass over the dispensing hole 12 subject to a predetermined setting. Because the control setting of the driving device 4 is of the known technology and not within the scope of the spirit of the present invention, no further detailed description in this regard is necessary.

Further, because the guide block 24 shaped like a truncated cone and located at the center of the top wall of the wheel body 21, the periphery of the guide block 24 guides the powder material to flow downwards toward the through holes 23 of the dispensing wheel 2. Further, the stir bar 241 that extends transversely from the flat topmost edge of the guide block 24 is rotated with the dispensing wheel 2 to stir up the powder material in the open chamber 31 inside the barrel 3 during operation of the driving device 4, facilitating downward movement of the powder material toward the through holes 23 of the dispensing wheel 2.

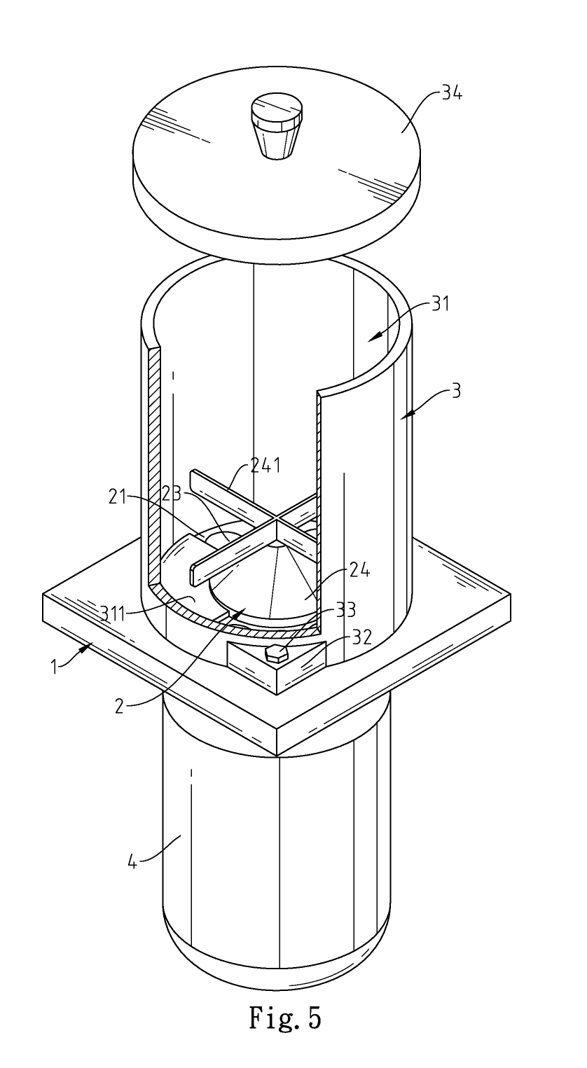

FIG. 5 illustrates an alternate form of the quantitative feed dispenser in accordance with the present invention. According to this alternate form, a cover 34 is detachably capped on the top side of the barrel 3 to close the top open side of the open chamber 31 against outside dust. Further, the stir bar 241 according to this alternate form is a crossed bar that stirs up the powder material efficiently during rotation.

Although particular embodiments of the invention have been described in detail for purposes of illustration, various modifications and enhancements may be made without departing from the spirit and scope of the invention.

What the invention claimed is:

1. A quantitative powder material dispenser, comprising:
a base frame, said base frame having a center coupling hole and a dispensing hole spaced from said center coupling hole at one side at a predetermined distance;
a dispensing wheel supported on and rotatable relative to said base frame, said dispensing wheel comprising a wheel body, said wheel body having a plurality of through holes cut through top and bottom walls thereof and equiangularly spaced from one another and a pivot shaft perpendicularly downwardly extended from the center of the bottom wall of said wheel body and inserted through the center coupling hole of said base frame;
a barrel fastened to said base frame around said dispensing wheel, said barrel defining therein an open chamber adapted for holding a powder material, said barrel comprising a scraper blade transversely mounted in said open chamber and kept in contact with said wheel body of said dispensing wheel above said through holes of said wheel body.

2. The quantitative powder material dispenser as claimed in claim 1, wherein said base frame comprises a plurality of mounting holes spaced around the border thereof; said barrel comprises a plurality of mounting blocks symmetrically disposed outside said open chamber and a plurality of mounting through holes respectively cut through said mounting blocks and respectively fastened to the mounting holes of said base frame by respective fastening members.

3. The quantitative powder material dispenser as claimed in claim 1, further comprising a driving device connected to said pivot shaft of said dispensing wheel and adapted for rotating said dispensing wheel.

4. The quantitative powder material dispenser as claimed in claim 1, wherein said dispensing wheel further comprises a guide block shaped like a truncated cone and located at the center of the top wall of said wheel body.

5. The quantitative powder material dispenser as claimed in claim 4, wherein said dispensing wheel further comprises a stir bar transversely extended from the topmost edge of said guide block.

6. The quantitative powder material dispenser as claimed in claim 5, wherein said stir bar is a crossed bar.

7. The quantitative powder material dispenser as claimed in claim 1, wherein said barrel further comprises a top cover detachably capped on a top open side of said open chamber.
